(19) United States
(12) Patent Application Publication
(10) Pub. No.: US 2008/0098325 A1
(43) Pub. Date: Apr. 24, 2008

(54) METHOD AND SYSTEM FOR FACILITATING SOCIAL PAYMENT OR COMMERCIAL TRANSACTIONS

(76) Inventors: Carnet Williams, Honolulu, HI (US); Olin Lagon, Honolulu, HI (US); Kevin Hughes, Honolulu, HI (US)

Correspondence Address: STRATEGIC PATENT GROUP, P.C., P.O. BOX 1329, MOUNTAIN VIEW, CA, 94042, US

(21) Appl. No.: 11/877,603

(22) Filed: Oct. 23, 2007

Related U.S. Application Data
(60) Provisional application No. 60/853,829, filed on Oct. 23, 2006.
(60) Provisional application No. 60/854,018, filed on Oct. 23, 2006.

(51) Int. Cl. G06F 3/048

(52) U.S. Cl. 715/781

(57) ABSTRACT

A system and computer implemented method for providing a widget are described. The widget is embeddable and for dynamically displaying multimedia content. The method and system include receiving an event configuration for an event, receiving a configuration of the widget, and allowing the widget to be copied to provide a copy. The widget is for dynamically displaying multimedia content related to the event, and is embeddable and copyable. The configuration includes the event with which the widget is associated. The multimedia content includes updatable tracking mechanism(s) for the event. The copy is embeddable, copyable, associated with the event, and displays at least a portion of the multimedia content. The copy has a copy configuration including at least one sub-campaign. The copy includes updatable sub-campaign tracking mechanism(s) for graphically tracking progress of the sub-campaign. The method and system also include rendering the copy on a site.

### CROSS-REFERENCE TO RELATED APPLICATIONS

The present application claims priority from co-pending provisional application Ser. No. 60/853,829, filed Oct. 23, 2006, entitled “Method and System for Facilitating Social Payment or Commercial Transactions”, and from co-pending provisional application Ser. No. 60/854,018, filed Oct. 23, 2006, entitled “Method and System for Facilitating Social Payment or Commercial Transactions”, both assigned to the assignee of the present application.

### BACKGROUND OF THE INVENTION

The World Wide Web has matured into an integral part of daily life for users around the world. The Internet may be used for commerce, social transactions, and sharing of multimedia content. For example, electronic commerce has grown significantly in recent years. Consumer commercial transactions that occur over the World Wide Web or use protocols that leverage the Internet such as SMTP (email) are collectively known as “electronic commerce.” The current model for electronic commercial transactions typically involves one merchant and one consumer engaging in a one-to-one transaction in which a consumer selects a set of goods and/or services and pays for those goods and/or services through the merchant, and the merchant fulfils the order. The Internet may also be used to facilitate merchants' ability to target potential consumers for commercial transactions. A merchant may customize advertisements and provide the advertisements to selected users. In Google™ AdWords, for example, the merchants' customized content may be selectively displayed based upon search terms users provide to Google™. The content provided also provides a mechanism for users to access the merchants' site and, therefore, make purchases. Similarly, affiliate marketing allows a promoter to serve up a static text/image link to a visitor that allows for a click through to a page set by an Organizer. If the visitor takes action as set by the Organizer (visit a page, complete a form, conduct a transaction, etc.) an Affiliate Marketing firm tracks this action that takes place on the Organizer's server and completes a transaction based on the agreement between the Organizer and Promoter. After an action is taken by a Visitor, the Promoter's text/image link is in no way modified to reflect this incremental action or changes in form, function, and content based on this incremental action. Such commercial mechanisms may be considered to be one-to-many, allowing a single merchant to reach a large number of consumers.

The World Wide Web has also experienced tremendous growth as a social media. As a social media, the World Wide Web provides a vehicle for sharing user generated content, such as through blogs, personal profiles, videos, podcasts, and the like. Platforms for sharing user generated content, such as Blogger, MySpace, YouTube, and Facebook have been developed and benefited from this growth. Other mechanisms for facilitating social interactions, such as eVite, have also grown. Using eVite, for example, an organizer may set up an event, sent invitation emails to potential participants, manage RSVPs, estimate budgets, and perform other functions related to the event via dedicated pages on eVite. Moreover, social media and fundraising combine in social payments to raise money for a variety of causes. Social media may be used to provide “Blogathons” that raise money for charities, political campaigns, allow musicians to appeal directly to their audience to underwrite albums, raise money for schools, parties, clubs and sports teams, or other causes. In such social payment transactions, organizers may solicit funds from other individuals visiting blogs or sites.

In order to display media for a variety of purposes, conventional widgets may be used. The conventional widgets are often used to display content from a widget owner to a user. For example, a user may load a page, or site, containing the conventional widget and view content, such as video, provided by the conventional widget. Conventional widgets are generally embeddable, portable applications that often run without access to a user's file system. The conventional widget may be copyable by users. Thus, a user may copy a widget from a site to a location of the user's choosing, for example the user's own blog. Conventional widgets are also generally small in size and less complex than typical applications, such as email or word processing applications. However, there is typically no agreed upon limitation in size or complexity for conventional widgets. Such widgets may be used, for example, by bloggers to share

Although electronic commerce and social transactions are possible via the World Wide Web, there are drawbacks. Many social and electronic commerce transactions involve many-to-many relationships. Such relationships are not well supported by current electronic commerce and social media platforms. In addition, the ability of tools, such as widgets, to reflect individual users' tastes may be limited. Consequently, users' ability to engage in social, commercial, and other transactions including sharing of multimedia content may be limited.

Accordingly, what is needed is a method and system for facilitating social and commercial transactions via the Internet. The present invention addresses such a need.

### BRIEF SUMMARY OF THE INVENTION

A system and computer implemented method for providing a widget are described. The widget is embeddable and for dynamically displaying multimedia content. The method and system include receiving an event configuration for an event, receiving a configuration of the widget, and allowing the widget to be copied to provide a copy. The widget is for dynamically displaying multimedia content related to the event, and is embeddable and copyable. The configuration includes the event with which the widget is associated. The multimedia content includes updatable tracking mechanism(s) for the event. The copy is embeddable, copyable, associated with the event, and displays at least a portion of the multimedia content. The copy has a copy configuration including at least one sub-campaign. The copy includes updatable sub-campaign tracking mechanism(s) for graphically tracking progress of the sub-campaign. The method and system also include rendering the copy on a site. In one aspect, an effectiveness percentage may be provided for the widget.

According to the method and system disclosed herein, social and other transactions via the Internet may be facilitated.

### BRIEF DESCRIPTION OF SEVERAL VIEWS OF THE DRAWINGS

FIG. 1 depicts one embodiment of a group payment system.

FIG. 2 depicts an exemplary embodiment of new account creation and organizer verification from the provider.

FIG. 3 depicts an exemplary embodiment of new event setup and event management.

FIG. 4 depicts an exemplary embodiment of a widget.

FIG. 5 depicts an exemplary embodiment of a widget.

FIG. 6 depicts an exemplary embodiment of widget overview and rendering.

FIG. 7 depicts exemplary embodiments of widgets.

FIG. 8 depicts another exemplary embodiment of a widget.

FIG. 9 depicts an exemplary embodiment of authentication of a widget.

FIG. 10 depicts another exemplary embodiment of a method for authenticating widgets.

FIG. 11 depicts an exemplary embodiment of a system utilizing a proxy server.

FIG. 12 depicts an exemplary embodiment of a method for moderating widgets.

### DETAILED DESCRIPTION OF THE INVENTION

The present invention relates to a method and system for providing a widget. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiments shown, but is to be accorded the widest scope consistent with the principles and features described herein.

A system and computer implemented method for providing a widget are described. The widget is embeddable and for dynamically displaying multimedia content. The method and system include receiving an event configuration for an event, receiving a configuration of the widget, and allowing the widget to be copied to provide a copy. The widget is for dynamically displaying multimedia content related to the event, and is embeddable and copyable. The configuration includes the event with which the widget is associated. The multimedia content includes updatable tracking mechanism(s) for the event. The copy is embeddable, copyable, associated with the event, and displays at least a portion of the multimedia content. The copy has a copy configuration including at least one sub-campaign. The copy includes updatable sub-campaign tracking mechanism(s) for graphically tracking progress of the sub-campaign. The method and system also include rendering the copy on a site

In one embodiment, a method and system for facilitating social payment and commercial transactions is described. The method and system utilize an embeddable application, or widget. The widget is part of a payment system that allows organizers to offer a variety of individuals to participate in activities such as fundraising. The widget is customizable for a particular organizer, in one embodiment through a widget panel. The widget may provide rich media to users and allow for the success of an event, campaign, and/or sub-campaign to be tracked. The widget allows for threaded text and rich media discussions/comments to be accessed through, recorded from, and uploaded through the widget itself. These discussions/comments may be published in real time throughout all widgets that relate to a specified campaign regardless of where the widget is being hosted from. That is, a comment can be made by a Web site visitor on a widget on one site set up by one Organizer and viewed in near real time by a different Web site visitor on another Widget hosted by another Organizer on a completely different Web site. Similarly, discussion/comments as well as other data may be published throughout only a selected portion of the widgets relating to a specified campaign. The widget may allow not only for direct, individual donations, to a campaign but also for sub-campaigns, or group payments, as options for fundraising, commercial transactions, and/or other analogous applications. In order to reach potential contributors, the widget may be posted on an organizer's site or blog, posted on a dedicated website, embedded into an email, embedded into an XML feed such as RSS, or pushed to particular sites. The widget may also be viral in nature, allowing for copying of the widget, for example to other sites or blogs. In the act of copying, a code for the source widget is transferred allowing for the tracking and data mining of generations of widgets. This copying is may be performed through the widget itself. The copied widget may also be customized. However, the widget may still be moderated by an organizer, allowing organizer control over sites on which the widget may function. Contributors may still make donations through the copied widget. Moreover, a tracking mechanism may be provided for the widget. For example, the effectiveness for content providers that carry such widgets may also be used to determine the efficiency of content providers in fundraising. In addition to allowing payment through the widget, the widget may also be authenticated. Moreover, widgets may be reused for other content. The widget may also reflect local data for the site hosting the widget. The widget may also be integrated with merchants or other organizers, for example through a button.

The method and system are mainly described in terms of particular systems provided in particular implementations. However, one of ordinary skill in the art will readily recognize that this method and system will operate effectively in other implementations. For example, the systems, devices, and networks usable with the present invention can take a number of different forms. For example, the method and system may not be limited to the Internet, but instead may be usable with other networks and/or devices, such as cellular telephones and other hand-held devices. The method and system are also described in the context of particular transactions being performed. One of ordinary skill in the art will recognize, however, that the method and system may be used in other transactions. The method and system will also be described in the context of particular methods having certain steps. However, the method and system operate effectively for other methods having different and/or additional steps not inconsistent with the present invention.

A method and system for facilitating social payment and commercial transactions is described. The method and system will be described in terms of particular components including a widget and payment system having specific components and features. However, one of ordinary skill in the art will realize that the widget and payment system may have other and/or different features and components not inconsistent with the method and system. In addition, the method and system primarily are described in the context of fundraising and social payment transactions. However, one of ordinary skill in the art will recognize that the method and system can be extended to other transactions including commercial transactions.

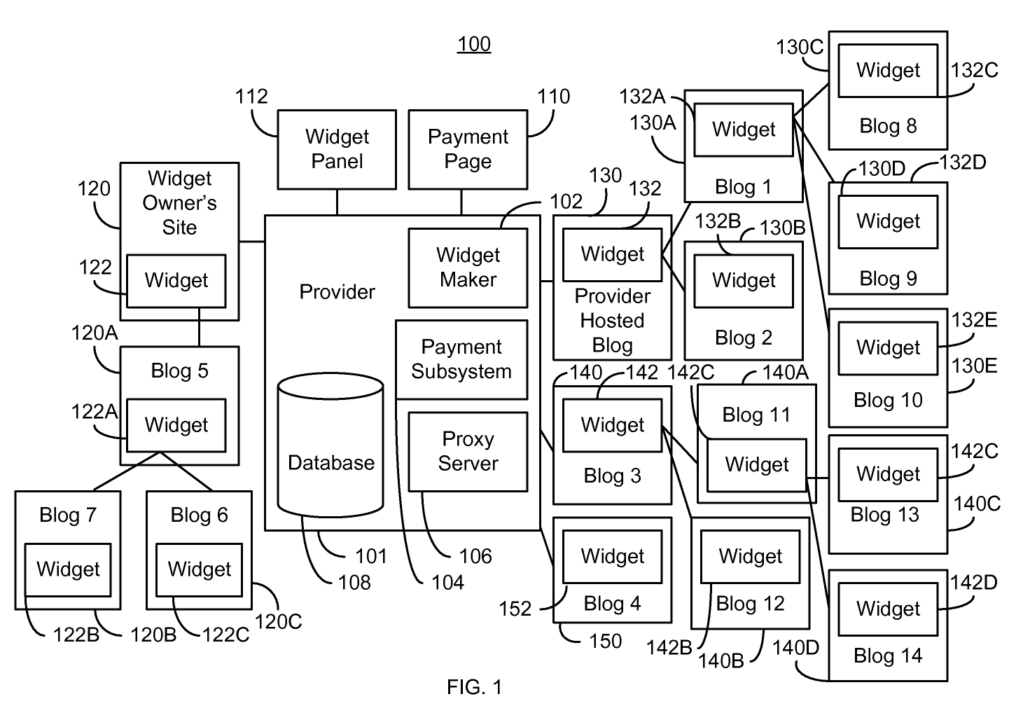

FIG. 1 depicts one embodiment of a system 100 in accordance with the method and system. The system 100 may be used for social payment transactions (i.e. fundraising). For example, an organizer such as a particular cause or charity may desire to use the system 100 for a variety of events. Such events might include a campaign based only on Internet contributions, blograising performed in conjunction with a traditional (non-Internet based) fundraising campaign, campaigns that want to drive and track traffic to a particular Web site, campaigns that want to drive and track visitor actions, campaigns based on the occurrence of a particular event, as an ongoing fundraising campaign, in a campaign of limited duration, or for other purposes. The system 100 allows an organizer to configure a widget for event(s), allows the widget to be disseminated, and manages payments or other data transmitted through the widget. The system 100 may include at least payment subsystem 104, widget maker 102, organizer data 106, widget(s) 122A, 122B, 122C, 132A, 132B, 132C, 132D, 132E, 142A, 142B, 142C, and 142D on sites 120, 130, 140, 150, 120A, 120B, 120C, 130A, 130B, 130C, 130D, 130E, 140A, 140B, 140C, and 140D, and, optionally, a proxy server 106. The system 100 may also utilize a widget panel 112 that allows an organizer to customize the widget and a payment page 110 through which the contributor actually makes a payment. The payment subsystem, widget maker, widget panel, and organizer data may be controlled by and accessed via a provider. The provider may, for example, charge a fixed fee or a percentage of donations for use of and services provided in connection with the system 100.

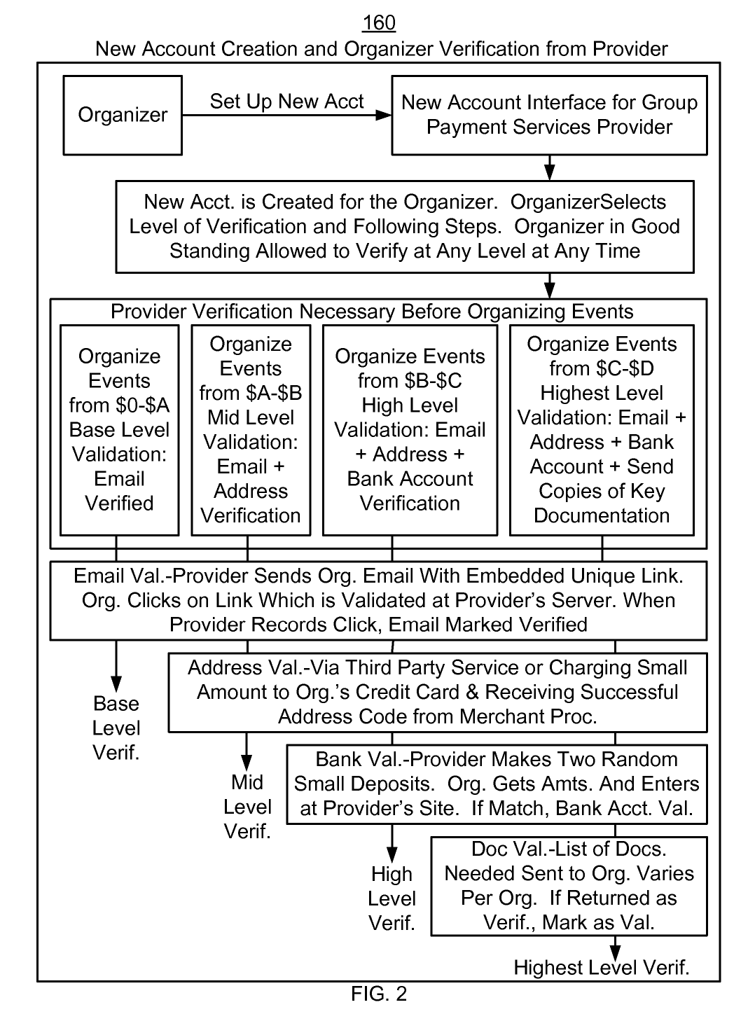

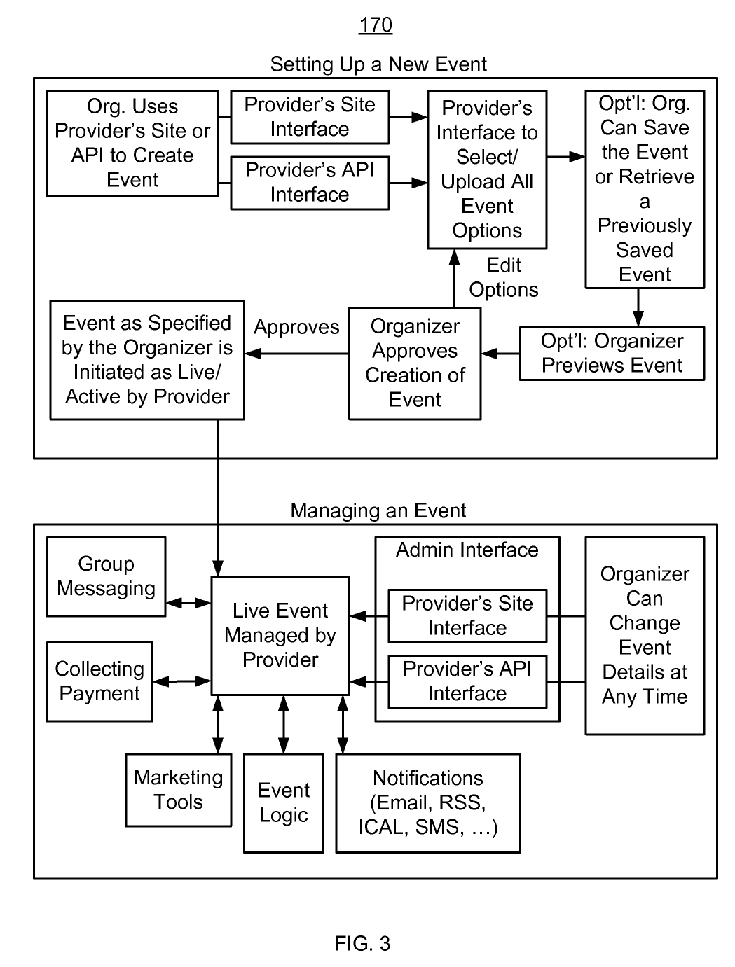

In operation, the organizer utilizes the widget maker 102 in order to customize a widget. In one embodiment, the widget maker provides a widget panel, which is a user interface that allows an organizer to provide input to the system used in customizing the widget. In one embodiment, the widget panel is a page presented to the organizer that allows the organizer to select features of the widget. For example, based on the organizer's elections in the widget panel, the widget maker sets the color, shape, event(s)/campaign(s) represented, rich media, level of detail and other aspects of the widget. The organizer may also specify that the widget is to be associated with specific event(s) and/or provide a profile for the type of events with which the widget is to be associated or content played on the widget. Thus, a single widget may be configured to display information related to multiple events. FIGS. 2-3 depict embodiments of methods 160 and 170, respectively, for creation and management of new accounts and/or events for which the widget may be generated.

The organizer's selections for the widget, as well as other data related to the organizer are stored in the organizer data 106. Thus, the organizer data includes organizer selected widget features, payment features, and event features. For example, widget features may include the content such as rich media displayed on the widget, thermometers or other mechanisms selected for tracking the progress of the campaign, colors, specific content providers authorized to host the widget, profiles of content providers authorized to host the widget, parameters related to updating the widget, and other data used in customizing the widget. The payment features may include allowed forms of payment, event tracking, rules for extracting funds, the look and feel of the payment page, and other data relating to payment. The event features may include event data such as the fundraising goal, event start time and duration, and the type of output for each event.

The payment subsystem 104 is utilized in managing the payments made and the payment page 110. Thus, the payment subsystem may authenticate users and/or forms of payment, track payments, validate extraction of funds, validate and track payments and forms of payment made to content providers, and otherwise manage the actual funds provided to the event or paid out from the event. In one embodiment, the payments may be validated and held by the provider or other designated third party (not shown) during the event. In such an embodiment, an organizer may be allowed to extract some or all of the funds. In an alternate embodiment, payments may not be considered made and extraction of funds may not be allowed until the event closes. Further, the payment subsystem may allow payments to content providers, organizers, and/or other designated entities in a variety of forms including but not limited to cash or the equivalent, gift cards, or other items.

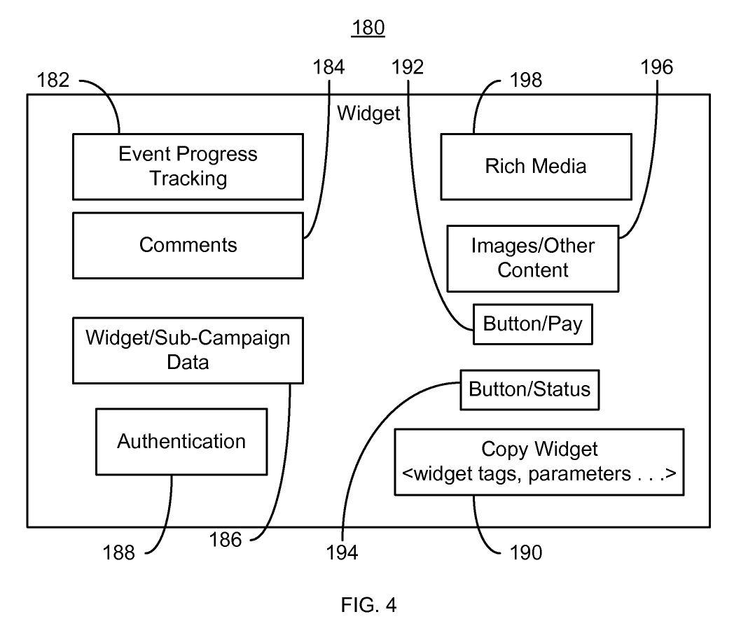

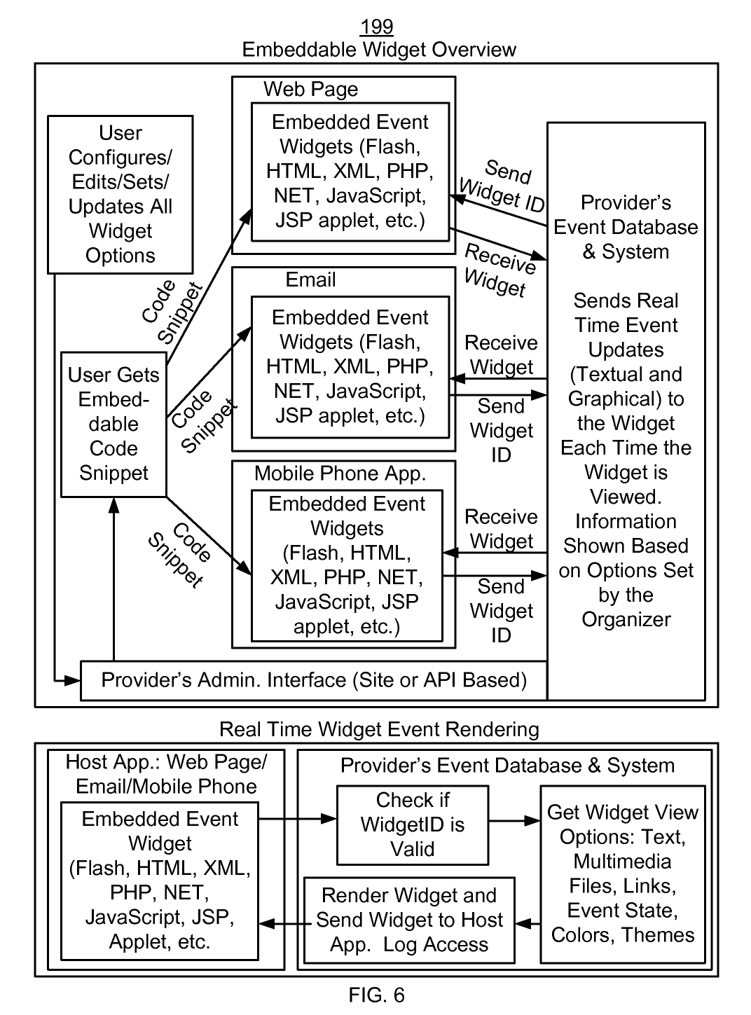

The widget 122, 132, 142, 152, 122A, 122B, 122C, 132A, 132B, 132C, 132D, 132E, 142A, 142B, 142C, and/or 142D is an embeddable code snippet, for example a Flash, HTML, XML, XHTML, SBML, NET, Java, JavaScript, JSP, VisualBasic Applet or analogous application. The widget may be embeddable in a multitude of architectures, for example web pages, mobile phones, PDAs, and/or provided via email. In addition, because the widget is embeddable, the widget is self-replicating in nature. Although the original code from the widget maker resides with the provider, the widget may be copied to multiple sites. In addition, the provider may be able to push data to widgets existing on other site as well as copies of the widget to new sites. Data may be pushed to all of the widgets or a selected portion of the widgets. Data may also be encrypted by the data source provider and decrypted by the widget based on private/public key cryptography, encryption, DES variants, passwords, or other secure means. Each widget also has identifiers, for example in a header, that may associate the widget with particular event(s), organizer(s), and/or content provider(s), indicate from which widget it was replicated (parent-child relationships), and allow the provider to validate and control the widget. When a potential contributor accesses the site, the provider may render the widget based upon the configuration selected by the organizer and/or content provider, accept content from widgets, allow and track payments via the widget, push content to the widget, and perform other tasks using the widget, as described below. FIGS. 4-5, and 7-8 depict various embodiments and features of the widget. Note that not all features of the widget are depicted in all embodiments of the widget. FIG. 6 depicts an exemplary embodiment 199 of an overview and corresponding real time for widget rendering.

Once configured, the widget 122, 132, 142, 152, 122A, 122B, 122C, 132A, 132B, 132C, 132D, 132E, 142A, 142B, 142C, and 142D may be placed in the organizer's page 120 and/or in a hosted page or blog 120, 130, 140, 150, 120A, 120B, 120C, 130A, 130B, 130C, 130D, 130E, 140A, 140B, 140C, and 140D. In one embodiment, the provider hosts a blog specifically for the event(s) associated with the widget. As a result, every event may have its own special URL. This unique address is tied to an organizer or individual that symbolizes a particular event or campaign. Further, the widget may be pushed to selected content providers (otherwise known as promoters) based upon the organizer's preferences and characteristics of the content providers. For example, suppose the organizer wishes to obtain contributions for a political campaign. The organizer may indicate that certain sites having compatible political views, that are known to reach a particular audience, that relate to a particular geographic area, and/or that have a requisite level of effectiveness in obtaining contributions are desired. Such sites may be Blog 3 and Blog 4 in FIG. 1. Further, the content providers of Blogs 3 and 4 may agree to host widgets for particular causes. If there is a match between the preferences of the organizer and the content providers of Blogs 3 and 4, the provider may push the widget for the political campaign to Blogs 3 and 4. In return, the content providers may receive payment for hosting the widget. Thus, because the widget has both many-to-one and one-to-many capabilities. Stated differently, a single widget may be associated with multiple events, organizers, or campaigns. In addition, a single fundraising event/campaign or events for a single organizer may be displayed on multiple widgets.

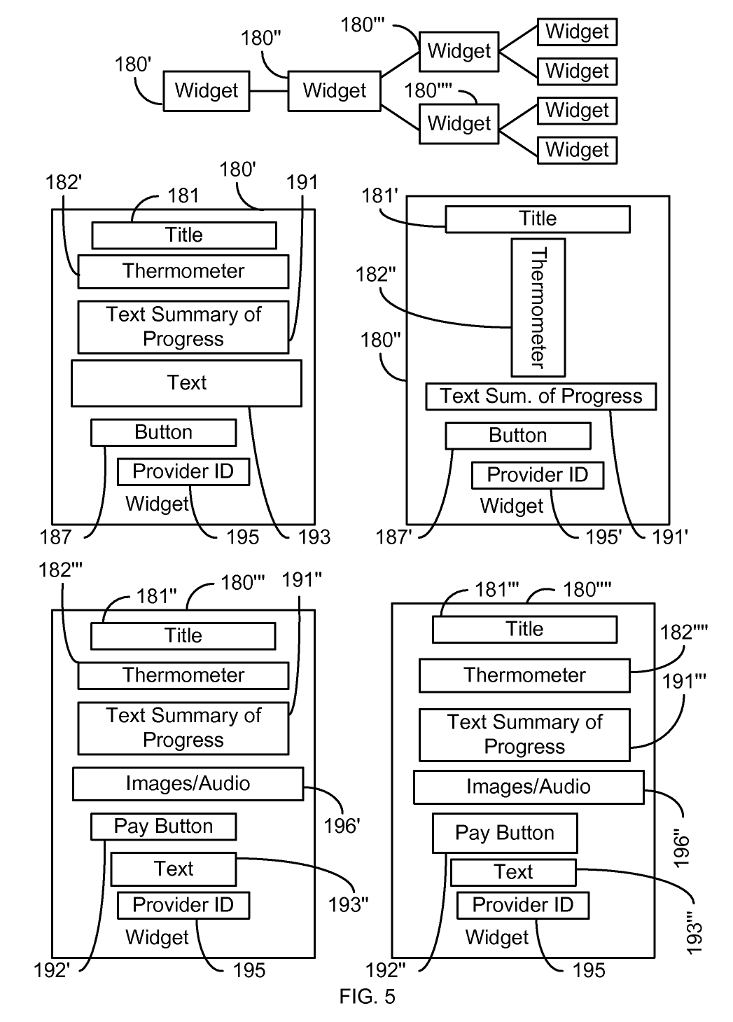

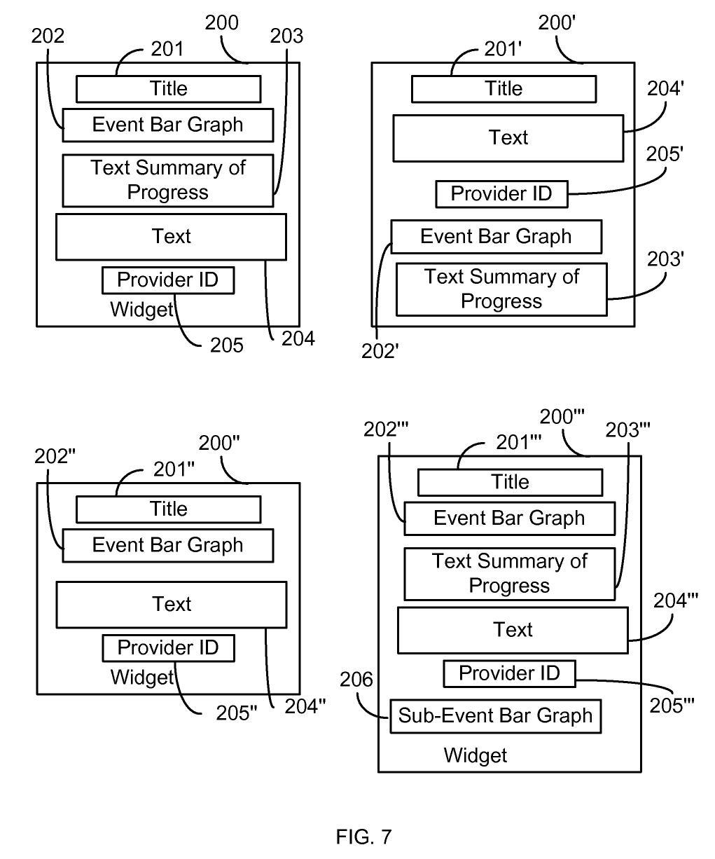

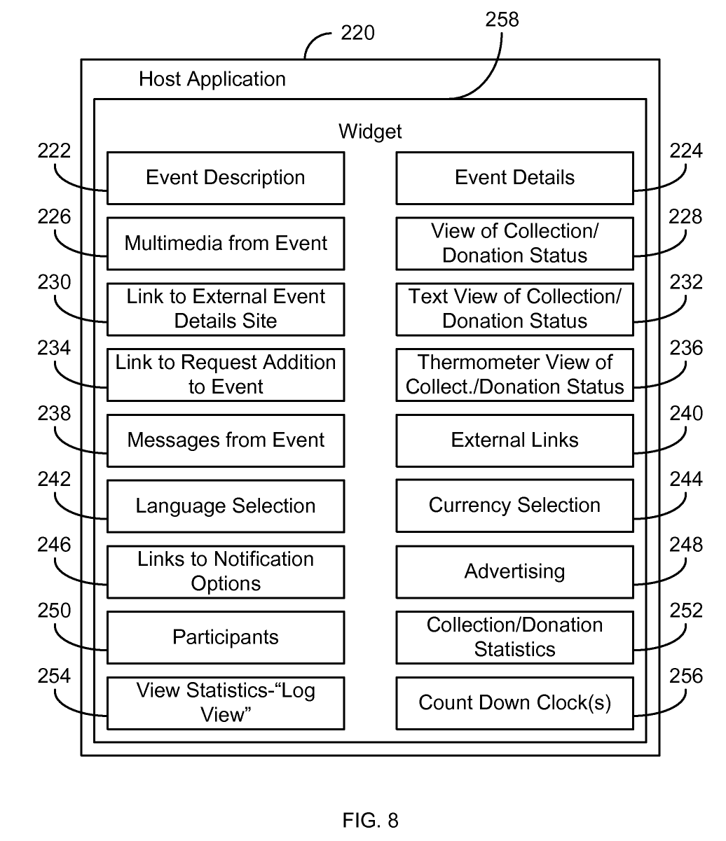

In addition to providing input to and receiving data from the provider, the widget may include several components for each event with which the widget is associated. These items may include as event progress tracking mechanisms, rich media, comments, payment buttons, status buttons, copying fields, sub-campaigns, and other features. These components, as well as the look and feel of the widget may be customized by the organizer. Further, the widget may be customized to change depending upon the status of the event or other input. For example, the rich media provided or comments displayed may change based upon how close an event is to terminating or the closing of a fundraising campaign. Examples of customized widgets are depicted in FIGS. 4, 5, and 7-8. FIG. 4 depicts a widget 180. FIG. 5 depicts a network of widgets 180′, 180″, 180″′, and 180″″. In FIG. 5, various examples of widgets 200, 200′, 200″, and 200″′ are shown. FIG. 6 depicts an exemplary embodiment 199 indicating the overview and event rendering. FIG. 7 depicts widget 200, 200′, 200″, and 200″′. FIG. 8 depicts a widget 220 and possible fields 222, 224, 226, 228, 230, 232, 234, 236, 238, 240, 242, 244, and 256.

The event progress tracking mechanisms, such as a thermometer, status bar, and/or count down clock, provide real time views of the event. Upon a refresh request and/or periodically based upon organizer and/or provider set preferences, the event progress tracking mechanisms may be updated by the provider to reflect any changes in the event. For example, upon donation from any of the widgets depicted in FIG. 1, the provider may push data to all (or some subset of) the widgets to reflect the change in the amount received. Thus, the level of a thermometer or status bar may change based upon real-time events. The event progress tracking mechanisms can be provided for the campaign(s) associated with the event or provider, as well as sub-campaigns, described below.

The widget may also include rich media customized by an organizer or other content provider. For example from an organizer can choose to include images as well as audio and/or video messages to encourage potential contributors to make a donation. Content providers might also be allowed add their own content to the widget on their site and copies thereof. The provider renders such rich media when the site hosting the widget is accessed by a potential contributor. Stated differently, the rich media discussions/comments can be published in real time throughout all widgets that relate to a specified campaign regardless of where the widget is being hosted from. Thus, threaded text and rich media discussions/comments may be provided via the widgets themselves.

The widget may also display and accept comments via the comments section. The comments provided by the organizer may appear in the comments sections. In addition, comments provided via one of the widgets of FIG. 1 may be disseminated by the provider to all or a subset of the widgets upon a refresh request and/or periodically based upon organizer and/or provider set preferences. The status buttons provide a mechanism for viewing further details relating to the event and/or organizer. Comments may be in textual or rich media format including video and audio.

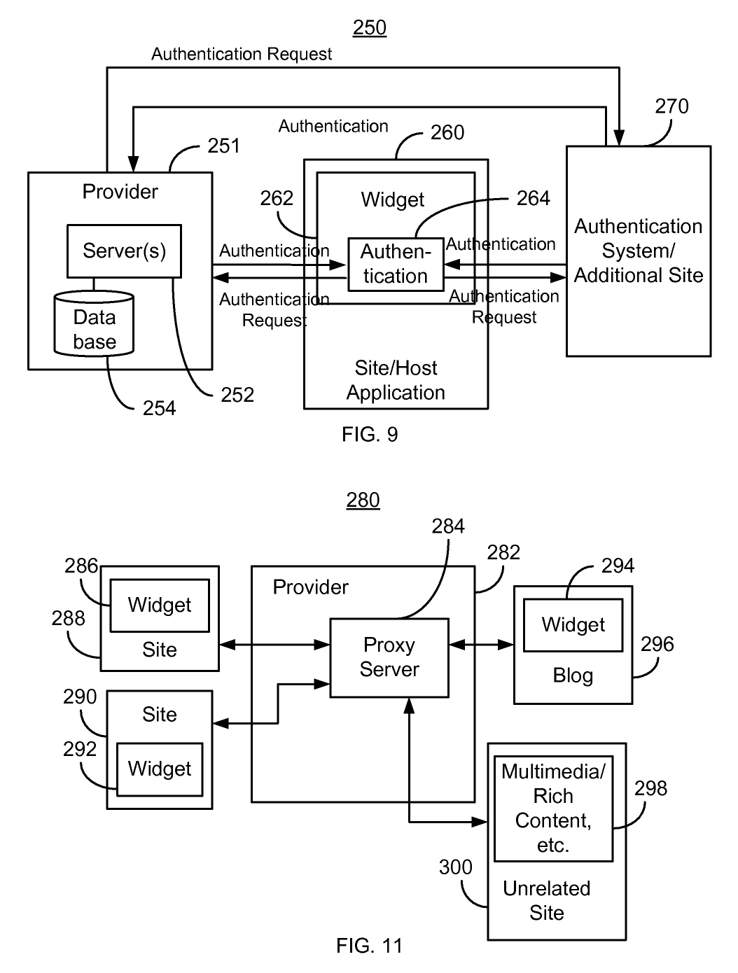

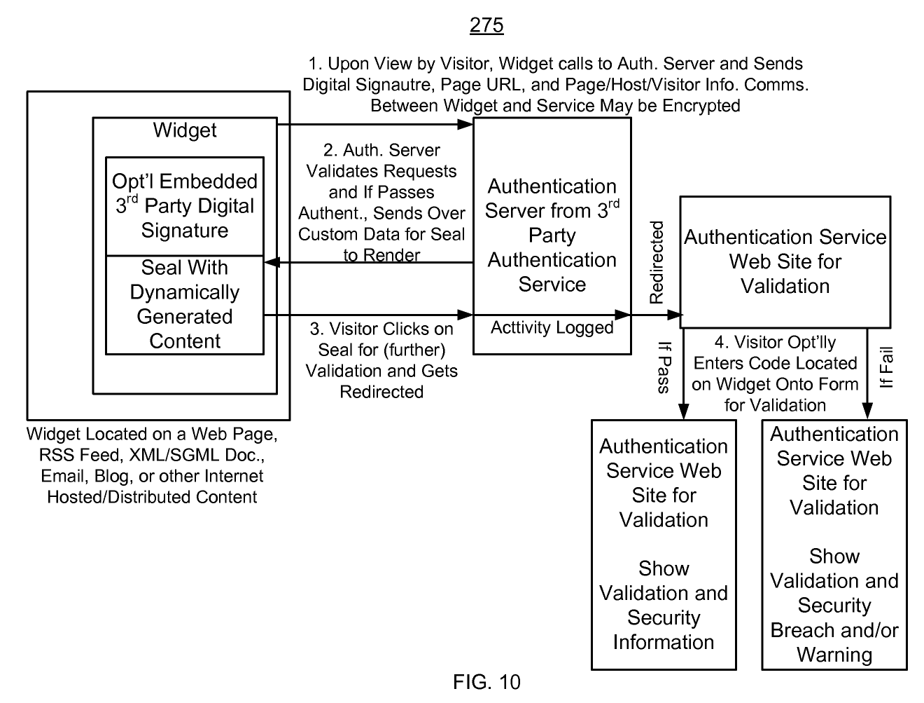

The payment buttons allow contributors to make payments through the widget without leaving the site hosting the widget. In one embodiment, selection of a payment button by a contributor results in the corresponding organizer-configured payment page being accessed. The contributor may then make a payment that is managed by the payment subsystem. In addition, the widget may be authenticated, which facilitates payment through the widget. For example, a user may click on an authentication button in the widget. The widget may then make a call back to one or more authentication services. The authentication received is passed back to the widget. Alternatively, a widget may automatically and/or periodically request authentication and present this to the user. This communication with authentication services may be performed via the provider. The authentication allows a user to have a greater level of assurance that payment through the widget is secure. FIGS. 9 and 10 depict embodiments 250 and 275, respectively, of authentication of the widget either directly with the third party authentication service or through the provider. Although FIG. 10 depicts a third party authentication service, in some embodiments, the third party authentication service might be created by the provider. Note that authentication of the widget may be extended to other embeddable applications, such as Flash applications. The authentication process may also use an embedded, dynamically generated by a third party, site seal on the widget. This embeddable seal may be provided in the form of a code snippet by a third party authentication firm to be embedded in the organization's widget. Before an organizer embeds the code snippet, they complete a validation process between itself and the third party authentication. Once authorized, embedded, and published live on the Internet, the visitor of the widget sees a dynamically generated seal directly within the widget that may also include dynamically generated code specific to that widget from the third party authentication firm. When a visitor clicks on the seal, they are taken to the trusted third party's site to authenticate that the widget is registered with the third party and to view any security levels, if present, that protects the visitor on widget to visitor communications. Upon arriving at the third party site for validation, the visitor may enter a code that is present on the seal. If the code entered matches what the third party expects for that seal, the profile of the company and other attributes are shared with the visitor. The third party may also use URL information to ensure, if desired, that a widget is being hosted on a Web page or other Internet host medium, if URL information is required as part of the authentication process. This might include an additional check that the source code of the widget remains with the trusted third party and/or has been checked by the third party and that the visitor is viewing an un-tampered version of a widget based on digital signature credentials embedded in the widget by the third party firm. The seal may also include dynamically generated content directly into the widget that show information including the current date and time to show visitors authentication information without having the visitor click through that the widget.

The widget may also allow copying through the widget, for example through copying field(s). The original code for the widget may reside with the provider. Consequently, upgrades, changes to the widget configuration made by the organizer, and other content may be pushed from the provider to the widgets. However, as discussed above, the widget is also self replicating and may, therefore, be copied and placed in multiple sites by multiple content providers. To facilitate this feature, copying field(s) may be provided. Embedded in the copied code may be a reference to the source widget as well as a new identification to identify the child widget. In addition to copying, an email may be requested so that the person copying the widget may request set up of an account identifying that person as the copier of that widget and thus retaining any tracking, benefits, or rewards as a result of traffic generated from the copied widget. The copying field allows the widget to be replicated through the widget itself. In one embodiment, the copying field provides a link that displays the code for the widget and allows a user to copy and paste the code to another site. Consequently, a separate field or a link to a different site for replicating the widget need not be provided. Moreover, a content provider may be allowed to customize the widget at least to a limited extent. Thus, replications or copies of a widget may not be identical to the widget. For example, the code for the widget includes an identification of the event(s) with which the widget is associated and parameters related to the size, shape, and color of the widget. The content provider copying the widget may be allowed change and/or add to the event(s) with which the widget is associated and alter the parameters to change the size, shape, and/or color of the widget displayed on the content provider's site.

In addition to being copied, for example through the copying field, in some embodiments, the widget may be copied to other sites through the proxy server. In particular, the organizer or a content provider may wish to replicate the widget on other site(s) not directly associated with the provider. In order to do so, the proxy server may provide an indirect connection to the other site(s), credential the site(s), and replicate the widget to the site(s). Furthermore, the proxy server may allow content, such as rich media audio or video, from site(s) not directly associated with the provider to be played on the widget. In addition, widgets may communicate directly through the proxy server, for example to disseminate comments, donation amounts, and/or other information. FIG. 11 depicts one embodiment 280 of the use of a proxy server 284 in conjunction with widgets.

Because the widget may be copied and further customized, sub-campaigns may be formed and tracked through the widget. For example, a content provider may copy a widget to his or her own site. The content provider may then be allowed to add a sub-campaign. In one embodiment, the content provider registers with the organizer (via the provider) in order to do so. The content provider may be allowed to specify the terms of the sub-campaign within the context of the campaign, but generally would not be authorized to alter the specifications of the campaign. The sub-campaign might be considered to be a group payment from contributors to the sub-campaign. Such a sub-campaign may be tracked, including using event progress tracking mechanisms in a manner analogous to the campaign. For example, an organizer may initiate a fundraising campaign for one million dollars and provide a campaign thermometer as the event progress tracking mechanism in the corresponding widget. A content provider might initiate a sub-campaign for five hundred dollars. This sub-campaign would be provided on a widget that has been copied (e.g. from the organizer's site), further customized, and placed on the content provider's site (e.g. their blog). The widget corresponding to the sub-campaign may provide event progress tracking in the form of a sub-campaign thermometer. The sub-campaign might include any contributions made through the content provider's widget and copies of the content provider's widget. A contributor may make a fifty dollar contribution to the sub-campaign. The provider updates both the campaign thermometer and the sub-campaign thermometer. Although the fifty dollar contribution would not significantly alter the campaign thermometer, such a contribution may be visible on the sub-campaign thermometer in the content provider's widget. Thus, further contributions are facilitated.

Data related to contributions through the widgets may also be tracked. As discussed above, contributors may make payments through any of the widgets in FIG. 1. Various aspects of payments made and other features of the widgets may be tracked. For example, the number and amount of payments made through a widget and/or its copies, the number of visits to the widget and/or its copies, the time the widget and/or its copies have been available, the amount of time taken by the widget and/or its copies to receive donations, user comments, and other data related to the widget may also be tracked by the provider. As a result, the provider may determine an effectiveness for various content providers and/or widgets. In one embodiment, an effectiveness percentage is determined based upon the number of views of a widget, the number of donors through the widget, the average contribution per donor, the aggregate donation through the widget, and analogous data for copies of the widget. Based on this effectiveness percentage, organizers may determine the content providers that are desired for particular campaigns.

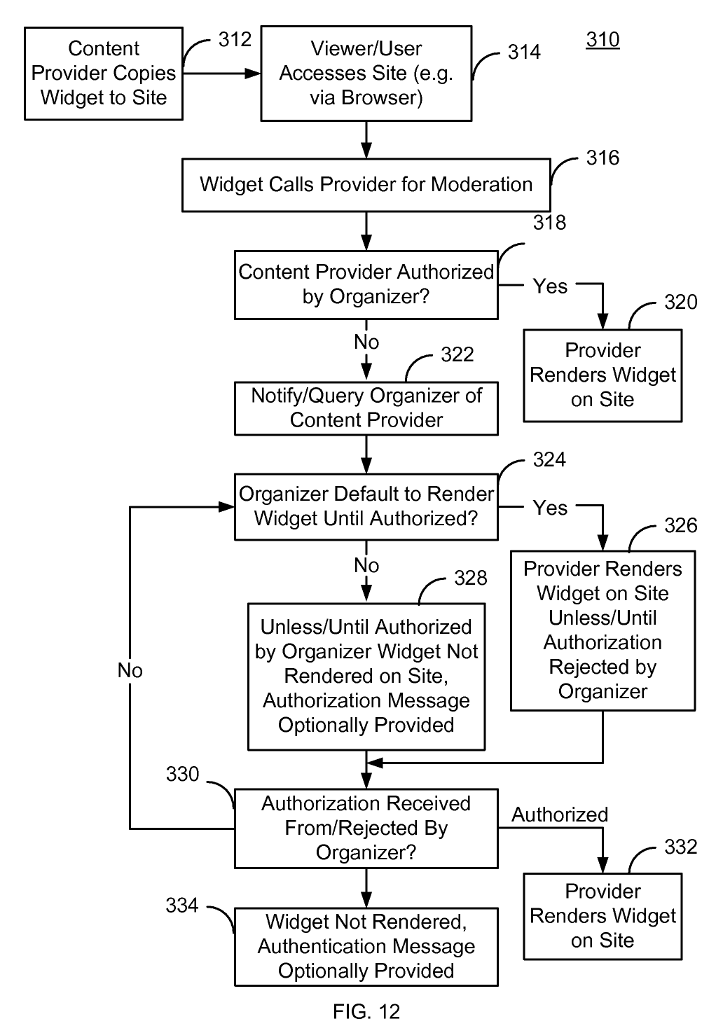

Although widgets may be copied, pushed to other sites, and sub-campaigns formed, these and other dissemination of the organizer's event may be moderated. Moderation allows the organizer to control the sites with which their widget, event, and the organizer themselves are associated. For example, the organizer may authorize only specific sites and/or sites fitting a particular profile to host the widget. The provider would not push the widget to sites not authorized by the organizer. If an unauthorized content provider copies the widget, then action may be taken based upon the organizer's preferences. For example, when the unauthorized content provider's site is accessed, the provider may send a message to the organizer requesting validation. In some embodiments, the widget may not be rendered until the organizer has expressly approved for the site. Alternatively, the widget may be rendered unless and until the organizer has expressly disapproved the site. FIG. 12 depicts one embodiment of a method 310 for moderating widgets.

The widgets may also reflect local data. The widget may be provided to multiple sites in a variety of ways, such as copies of widgets from the organizer's site, copies of widgets from provider's site, and copies of widgets from other content provider's sites, pushing the widget to specific sites, and allowing subsequent copying of the pushed widget. These copies may reside on sites subject to local conditions. For example, the sites may serve distant geographic locations, disparate countries, multiple time zones, and users speaking different languages. In one embodiment, the widget may be configured to account for at least some of these local conditions. For example, the event progress tracking mechanism may display the donations using the local currency and indicate relevant times using the local time. In order to do so, the widget may query the local computer system hosting the site to obtain local data, such as the time and/or language. The widget may then convert various components to reflect the local data. For example, the language may be translated to the local language and/or the time of relevant occurrences such as the event ending may be updated to reflect the local time.

The widgets may also be reusable. As discussed above, the widget may be copied and/or pushed to sites. Once a widget resides on a site, it may remain on the site unless and until expressly removed by the content provider or the provider. Furthermore, data may be pushed to widgets by the provider. The widgets are generally associated with particular events that have specific closing dates, such as a fundraising campaign. Once the event closes or for some other reason the widget is not longer associated with the event, the widget may be available for reuse. The widget may be reused by the provider pushing data to the widget and/or by the content provider re-customizing the widget for new events. For example, when configuring the widget, an organizer may indicate that once an event has closed, specific content is to be pushed to the associated widgets. This content could be a thank you message, an indication of other events that may be of interest to the content provider, or settings that reconfigure the widget for another event. Similarly, a content provider could reconfigure the widget to be associated with another event or indicate to the provider that the widget may be reused for other events meeting certain criteria. The provider may push new settings and parameters to the widgets residing on other sites based on content providers' and organizers' specifications. For example, a content provider may specify that the widget on its site is available for causes fitting particular profiles. The provider may then push data to the widget on the content provider's site to reuse the widget for events fitting the profiles. The content provider may be paid or otherwise rewarded for use and/or reuse of the widget on the content provider's site.

Thus, a method and system for facilitating social payment, commercial, and/or other transactions via the Internet is described. The method and system utilize a highly customizable widget that is easily integrated into social media. The customizable widget may provide rich media to users, provide event progress tracking, and may allow for the effectiveness of the widget to be determined. The widget allows not only for direct, individual donations, to a campaign but also for sub-campaigns, which are analogous to group payments. In order to reach potential contributors, the widget may be posted on an organizer's site or blog, posted on a dedicated website or pushed to various sites. The widget may also be viral in nature, allowing for copying of the widget, for example to other sites or blogs. Because this copying may be performed through the widget itself, the copying is further facilitated. Consequently, a powerful blograising network may be created. The copied widget may still be customized and contributors may still make donations through the copied widget. However, the widget may still be moderated by an organizer. Consequently, an organizer may remain in control of the image of the organizer and/or event. In addition to allowing payment through the widget, the widget may also be authenticated. Consequently, social payments may be made simpler and more trustworthy. Moreover, widgets may be reused for other content. Thus, the ability to repeatably provide fundraising through the blograising network is improved. The widget may also reflect local data for the site hosting the widget, facilitating the interaction of the potential contributor and the organizer. The widget may also be integrated with merchants or other organizers, for example through a button. According to the method and system disclosed herein, social payment, commercial, and other transactions may be facilitated.

A method and system providing and utilized widgets have been disclosed. The present invention has been described in accordance with the embodiments shown, and one of ordinary skill in the art will readily recognize that there could be variations to the embodiments, and any variations would be within the spirit and scope of the present invention. For example, the present invention can be implemented using hardware, software, a computer readable medium containing program instructions, or a combination thereof. Software written according to the present invention is to be either stored in some form of computer-readable medium such as memory or CD-ROM and is to be executed by a processor. Consequently, a computer-readable medium is intended to include a computer readable signal, which may be, for example, transmitted over a network. Accordingly, many modifications may be made by one of ordinary skill in the art without departing from the spirit and scope of the appended claims.

We claim:

1. A computer implemented method for providing a widget comprising:
receiving an event configuration for an event;
receiving a configuration of the widget, the widget for dynamically displaying multimedia content related to the event, the widget being embeddable and copyable, the configuration including the event with which the widget is associated, the multimedia content including at least one updatable tracking mechanism for the event;
allowing the widget to be copied to provide a copy, the copy being embeddable, copyable, associated with the event, and displaying at least a portion of the multimedia content, the copy having a copy configuration including at least one sub-campaign, the copy including at least one updatable sub-campaign tracking mechanism for graphically tracking progress of the sub-campaign; and
rendering the copy on a site.

2. The method of claim 1 wherein the copy has an effectiveness percentage determined based upon at least one of a number of views of the copy, a number of donors through the copy, an average contribution per donor, an aggregate donation through the copy.
